(19) United States
(12) Patent Application Publication
(10) Pub. No.: US 2017/0297391 A1
(43) Pub. Date: Oct. 19, 2017

(54) WIRELESS SENSOR SYSTEM FOR TRAILER COMMUNICATION

(71) Applicant: Joe Pilliod, Bonham, TX (US)

(72) Inventor: Joe Pilliod, Bonham, TX (US)

(21) Appl. No.: 15/098,732

(22) Filed: Apr. 14, 2016

(51) Int. Cl. B60D 1/24; B60D 1/62; H04L 29/08; H04W 4/00

(52) U.S. Cl. CPC B60D 1/24; H04L 67/12; B60D 1/62; H04W 4/008

(57) ABSTRACT

A wireless sensor system for a trailer including: a vehicle; a vehicle sensor, where the vehicle sensor is adapted to plug into the vehicle; a trailer hitch attached to the vehicle; a trailer; a trailer bracket, where the trailer bracket connects to the trailer hitch; a trailer sensor attached to the trailer and said trailer sensor is adapted to receive signals from the vehicle sensor; a power source for the trailer and components including the trailer sensor; and a wireless connection between the vehicle sensor. Preferably the vehicle is a truck and the power source is a solar panel. The vehicle sensor includes a plugin that connects to a trailer light plug of the vehicle. The vehicle sensor syncs any vehicle traffic signaling with trailer traffic signaling via the trailer sensor.

### BACKGROUND OF THE INVENTION

### Field of Invention

The present invention relates to a wireless system that is used to communicate trailer and vehicle signaling.

### Description of Related Art

Trailers commonly hitch to vehicles typically a truck or some type of other vehicles that are equipped with a hitch that allow the attachment of trailers. Once the trailer is attached to the vehicle signaling associated with the vehicle must be transmitted to the trailer for safety purposes. Typically, a wire and a socket are available to connect to the trailer so that there is communication of braking and turn signals to the trailer lights. This wire connection enables safe driving and visibility of the vehicle and trailer. One drawback to the additional wiring as used is that occasionally this wiring may break or become disabled due to an improper connection. It is imperative that the trailer lights are synced with the vehicle signal. It is imperative that this syncing of the vehicle lights with the trailer lights is consistent and available at all times. The prior art fails to provide any effective wireless solutions that can sync the vehicle lighting with the trailer lighting. As a result, such a system would be an innovative solution to assist in the communication between the vehicle and the trailer during operation.

### SUMMARY OF THE INVENTION

The present invention relates to a wireless sensor system for a trailer including: a vehicle; a vehicle sensor, where the vehicle sensor is adapted to plug into the vehicle; a trailer hitch attached to the vehicle; a trailer; a trailer bracket, where the trailer bracket connects to the trailer hitch; a trailer sensor attached to the trailer and said trailer sensor is adapted to receive signals from the vehicle sensor; a power source for the trailer and components including the trailer sensor; and a wireless connection between the vehicle sensor. Preferably the vehicle is a truck and the power source is a solar panel. The vehicle sensor includes a plugin that connects to a trailer light plug of the vehicle. The vehicle sensor syncs any vehicle traffic signaling with trailer traffic signaling via the trailer sensor.

### BRIEF DESCRIPTION OF DRAWINGS

FIG. 1 depicts a wireless sensor system for a trailer and vehicle connection in accordance with the present invention.

FIG. 2 depicts sensors used within the wireless sensor system according to the present invention.

### DETAILED DESCRIPTION

The present invention relates to a wireless sensor system for a trailer implemented with a vehicle during the towing of a trailer. The present invention includes plugging the sensor into the vehicle and an additional receiving plug-in sensor to the trailer. These sensors communicate wirelessly indicating signaling associated with the vehicle. The signaling transmits application of brakes, turn signals and tail lights that are coordinated between the vehicle and the trailer. The present system therefore eliminates the need for hard wiring of the trailer to the vehicle in order for signal, braking and night lighting requirements. Once installed this system provides effective and necessary signaling system between the vehicle and the trailer.

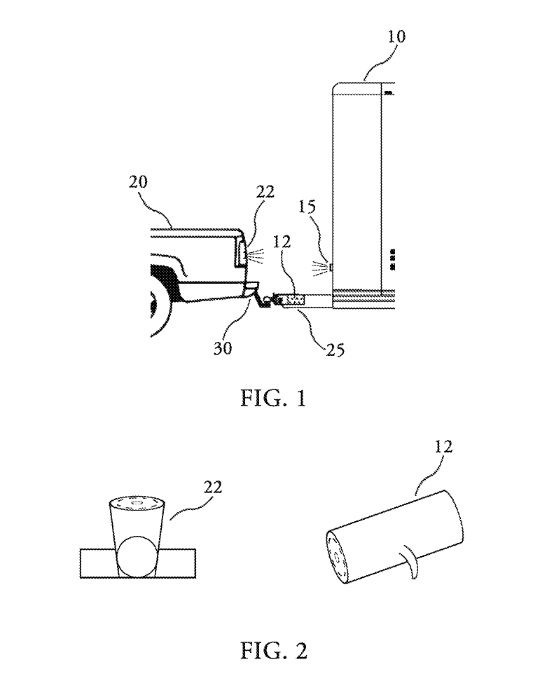

In reference to FIG. 1, a depiction of the wireless sensor system according to the present invention is shown. A vehicle 20 and a trailer 10 are connected to a trailer hitch 30. The vehicle 20 includes a plug-in sensor 22 that communicates with the sensor 15 that is connected to the trailer 10. These communications communicate signaling between the vehicle and the trailer 10. An additional plug-in 12 is provided on the bracket 25 of the trailer 10. The present invention enables wireless communications between the vehicle signaling and the trailer powered with power sources provided for the trailer, such as a solar power source not shown in the figures. Once connected the system enables the user to have a wireless transmission of signaling between the truck 20 and trailer 10. FIG. 2 depicts a vehicle plug-in 22 and a trailer bracket plug-in 12 that are also shown prior to being plugged in. The plug-in available for the vehicle 20 may feature a seven-blade plug-in or four-hole plug so that the sensor is incorporated into the back of the vehicle. The wireless connection between the vehicle sensor and the trailer sensor may be in the form of Bluetooth technology however other wireless communications may be implemented. The instant invention has been shown and described in what it considers to be the most practical and preferred embodiments. It is recognized, however, that departures may be made there from within the scope of the invention and that obvious modifications will occur to a person skilled in the art.

1. A wireless sensor system for vehicle to trailer communication comprising:
a. a vehicle;
b. a vehicle sensor, where the vehicle sensor is adapted to plug into the vehicle and includes a plugin that connects to a trailer light plug of the vehicle;
c. a trailer hitch attached to the vehicle;
d. a trailer;
e. a trailer bracket, where the trailer bracket connects to the trailer hitch;
f. a trailer sensor attached to the trailer and said trailer sensor is adapted to receive signals from the vehicle sensor;
g. a power source for the trailer and components including the trailer sensor; and
h. a wireless connection to the vehicle sensor.

2. The wireless sensor system according to claim 1, where the vehicle is a truck.

3. The wireless sensor system according to claim 1, where the power source is a solar panel.

4. The wireless sensor system according to claim 1, where the wireless connection is a Bluetooth enabled.

5. (canceled)
